(19) United States
(12) Patent Application Publication
(10) Pub. No.: US 2007/0132717 A1
(43) Pub. Date: Jun. 14, 2007

(54) INPUT DEVICE AND METHOD OF LOCKING A COMPUTER SYSTEM

(75) Inventors: Han-Che Wang, Shenzhen (CN); Kuan-Hong Hsieh, Shenzhen (CN); Wen-Chuan Lian, Shenzhen (CN); Xiao-Guang Li, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,750

(22) Filed: Sep. 21, 2006

(30) Foreign Application Priority Data
Dec. 10, 2005 (CN) 200510102284.6

(51) Int. Cl. G09G 5/00

(52) U.S. Cl. 345/156

(57) ABSTRACT

An input device capable of locking a computer system is provided. The input device has an interface, a pressure sensor, and a microcontroller. The interface is for communicating with the computer system. The pressure sensor is for generating pressure sensing signals if pressed. The microcontroller is configured for scanning occurrence of the pressure sensing signals in real time, and generating and transmitting a lock signal through the interface to signal the computer system to perform a system lock operation if the microcontroller has not detected the pressure sensing signals in a predetermined time period. A related method is also provided.

### TECHNICAL FIELD

The present invention relates to input devices and methods therefore, and particularly to an input device and method of locking a computer system connected thereto.

### GENERAL BACKGROUND

Security systems of various kinds are well known in the art for computer systems and computer related applications. These security systems have been designed to safeguard sensitive information that may be stored or processed within computer systems and to prevent unauthorized access to the computer's operating system in the event that an authorized user(s) is away from the computer. The desirability for computer security systems has increased significantly over recent years with the proliferation of personal and business computer systems and with the storage of increasingly valuable and/or classified information within these computers systems.

For example, in one prior computer security system, the authorized user(s) shuts down the computer system when he/she leaves the computer. Consequently, a user enters a password during boot up in order to gain access to information within the computer system. If entered an incorrect password, the user, namely the unauthorized or illegal user, cannot access the computer system, thereby protecting information security of the computer system. However, in this prior computer security system, the authorized user(s) may waste some time to reboot the computer system.

Therefore, in order to resolve inconvenience of reboot the computer system, another two prior computer security systems are introduced. In one computer security system, the user is able to lock the keyboard through a designated series of keystrokes (i.e. password) when he/she leaves away from the computer. The user can then regain access to the computer system by entering the correct password on the keyboard. In another computer security system, the keyboard automatically locks after the keyboard remains inactive over a present time interval. After the keyboard locks, when a key is pressed, the user is prompted to enter a password. Once the user enters a correct password, the keyboard becomes fully active, and operations of the computer system begins where it stopped. However, in these two prior computer security systems, the user is still not able to promptly, conveniently lock the computer system.

What is needed, therefore, is an input device and method of locking the computer system, which can enable the user to promptly, conveniently lock the computer system.

### SUMMARY

An input device capable of locking a computer system is provided. The input device has an interface, a pressure sensor, and a microcontroller. The interface is for performing data communication between the input device and the computer system. The pressure sensor is for generating pressure sensing signals if pressed thereon. The microcontroller is configured for scanning occurrence of the pressure sensing signals in real time, and generating and transmitting a lock signal to signal the computer system to perform a system lock operation if the microcontroller has not detected the pressure sensing signals in a predetermined time period.

A method enabling an input device to lock a computer system is also provided, wherein the input device has a pressure sensor for generating pressure sensing signals if pressed. The method includes the steps of: (a) scanning occurrence of the pressure sensing signals in real time; (b) generating a lock signal if not detecting the pressure sensing signals in a predetermined time period; and (c) transmitting the lock signal to the computer system thereby signaling the computer system to perform a system lock operation.

Other advantages and novel features will be drawn from the following detailed description with reference to the attached drawing, in which:

### BRIEF DESCRIPTION OF DRAWINGS

FIG. 1 is an exemplary schematic diagram of a hardware infrastructure of an input device capable of locking a computer system connected thereto in accordance with a preferred embodiment of the present invention; and

FIG. 2 is a flowchart of a preferred method for locking the computer system by utilizing the input device of FIG. 1.

### DETAILED DESCRIPTION

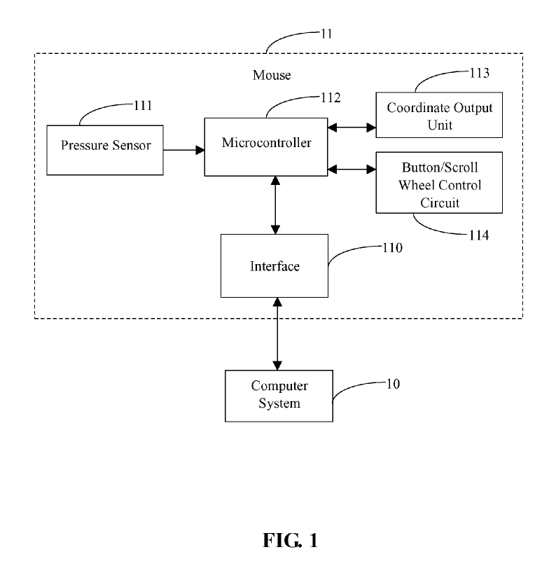

FIG. 1 is an exemplary schematic diagram of a hardware infrastructure of an input device in accordance with a preferred embodiment of the present invention. The input device 11 is a peripheral device, typically a pointing device such as, for example, a mouse, a joy stick, a track ball, etc, which not only enables easier control of a cursor on a display of a computer system 10 connected thereto, but can also generate a lock signal to lock the computer system 10.

In this exemplary embodiment, the mouse is provided as an example. The mouse 11 has an interface 110, a pressure sensor 1111, a microcontroller 112, a coordinate output unit 113, and a button/scroll wheel control circuit 114. The interface 110, the microcontroller 112, the coordinated output unit 113, and the button/scroll wheel control circuit 114 are structured and arranged as well as a normal mouse has.

The interface 110 is for performing data communication between the mouse 11 and the computer system 10. Consequently, the interface 110 can be any appropriate communication media such as, for example, a Universal Serial Bus (USB) interface, a PS/2 (Personal System/2) interface, and so on.

The coordinate output unit 113 is for outputting coordinates corresponding to movements of the mouse 11 to the microcontroller 112, and the microcontroller 112 thereupon transmits the coordinates to the computer system 10 through the interface 110. The button/scroll wheel control circuit 114 is for processing operations of both buttons and scroll wheel of the mouse

The pressure sensor 111 is preferably configured (i.e., structured and arranged) at the bottom of the mouse 11 for sensing pressure thereon. Accordingly, the pressure sensor 111 is able to generate pressure sensing signals if the mouse 11 is kept upright on a support surface, whereas, the pressure sensor 111 does not generate the pressure sensing signals if the mouse 11 is not kept upright on the support surface. For example, if the mouse 11 is placed sideways or is in an overturned state, the pressure sensor 111 is not pressed, thus not generating the pressure sensing signals.

The microcontroller 112 is configured (i.e., structured and arranged) for scanning occurrence of the pressure sensing signals from the pressure sensor 111 in real time. If a duration in which the microcontroller 112 has not detected the pressure sensing signals reaches a predetermined value, the microcontroller 112 generates a lock signal to lock the computer system 10, and transmits the lock signal to the computer system 10 through the interface 110. Accordingly, in response to the lock signal, the computer system 10 is signaled to perform a system lock operation to enable itself to enter a lock state, thereby preventing unauthorized users to access the computer system 10.

Therefore, a user of the computer system 10 can promptly and conveniently lock the computer system 10 through a simple operation on the mouse 11 such as, for example, turning over the mouse 11 or placing the mouse 11 sideways.

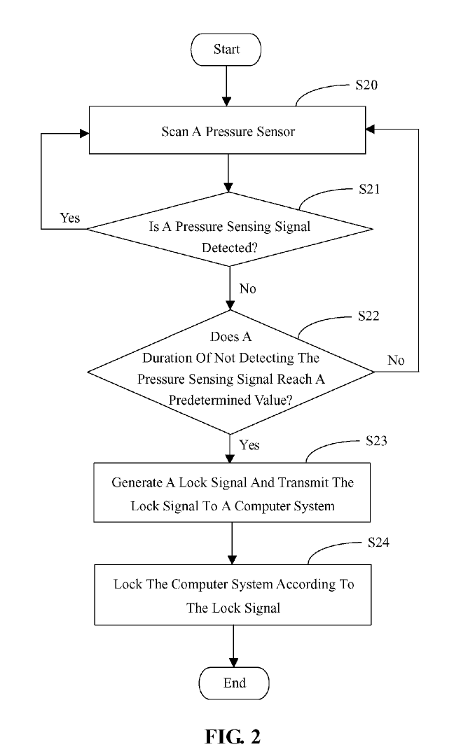

FIG. 2 is a flowchart of a preferred method for locking the computer system 10 by utilizing the input device 11 of FIG. 1. In step S20, the microcontroller 112 scans occurrence of the pressure sensing signals from the pressure sensor 10 in real time.

In step S21, the microcontroller 112 detects whether it receives the pressure sensing signals. If the microcontroller 112 detects the pressure sensing signals, the procedure returns to step S20 described above.

If the microcontroller 112 does not detect the pressure sensing signals, in step S22, the microcontroller 112 clocks whether a duration in which it has not detected the pressure sensing signals reaches a predetermined value. If the duration in which the microcontroller 112 has not detected the pressure sensing signals does not reach the predetermined value, the procedure returns to step S20 described above.

If the duration in which the microcontroller 112 has not detected the pressure sensing signals reaches the predetermined value, in step S23, the microcontroller 112 generates the lock signal to lock the computer system 10, and transmits the lock signal to the computer system 10 through the interface 110.

In step S24, the computer system 10 is signaled to perform the system lock operation in response to the lock signal, thereby preventing unauthorized users to access the computer system 10, and the procedure is finished.

Although the present invention has been specifically described on the basis of a preferred embodiment and preferred method thereof, the invention is not to be construed as being limited thereto. Various changes or modifications may be made to the embodiment and method without departing from the scope and spirit of the invention.

What is claimed is:

1. An input device capable of locking a computer system, the input device comprising:
an interface for communicating with the computer system;
a pressure sensor for generating pressure sensing signals if pressed; and
a microcontroller configured for scanning occurrence of the pressure sensing signals in real time, and generating and transmitting a lock signal through the interface to signal the computer system to perform a system lock operation if the microcontroller has not detected the pressure sensing signals in a predetermined time period.

2. The input device according to claim 1, further comprising a coordinate output circuit for outputting coordinates corresponding to movements of the input device to the computer, thereby enabling a control of a cursor on a display of the computer system.

3. The input device according to claim 2, wherein the interface, the microcontroller, and the coordinate output circuit are structured and arranged as well as a pointing device which is selected from the group consisting of a mouse, a joy stick, a track ball.

4. The input device according to claim 3, wherein the pressure sensor is configured at the bottom of the input device.

5. A method enabling an input device to lock a computer system, wherein the input device has a pressure sensor for generating pressure sensing signals if pressed, the method comprising the steps of:
scanning occurrence of the pressure sensing signals in real time;
generating a lock signal if not detecting the pressure sensing signals in a predetermined time period; and
transmitting the lock signal to the computer system thereby signaling the computer system to perform a system lock operation.
